(19) United States
(12) Patent Application Publication
(10) Pub. No.: US 2019/0283808 A1
(43) Pub. Date: Sep. 19, 2019

(54) ROOF CONSTRUCTION FOR A MOTOR VEHICLE HAVING AT LEAST ONE ROOF RAIL

(71) Applicant: Ford Global Technologies, LLC, Dearborn, MI (US)

(72) Inventor: Bernhard Kreuzer, Bergisch Gladbach (DE)

(21) Appl. No.: 16/283,970

(22) Filed: Feb. 25, 2019

(30) Foreign Application Priority Data
Mar. 14, 2018 (DE) 102018203868.6

(51) Int. Cl. B62D 25/06; B62D 27/06; B62D 27/02

(52) U.S. Cl. CPC B62D 25/06; B62D 27/023; B62D 27/065

(57) ABSTRACT

This disclosure relates to a roof construction for a motor vehicle. In an example, the roof construction includes two side walls, a cross bar extending between the two side walls, a retaining plate connected to the cross bar, a roof panel, and a roof rail connected to the roof panel by a fastener passing through the retaining plate and the roof panel. The construction of this disclosure is not only less costly but requires less maintenance than prior designs.

### RELATED APPLICATION(S)

This application claims priority to German Patent Application No. 102018203868.6, filed on Mar. 14, 2018, the entirety of which is herein incorporated by reference.

### TECHNICAL FIELD

This disclosure relates to a roof construction for a motor vehicle having at least one roof rail.

### BACKGROUND

Some motor vehicles include roof rails, which extend along the sides of the roof, and which are used as mounting points for gear, such as luggage or sporting equipment, as examples. Roof racks may extend between the roof rails. Some roof racks are adapted to hold certain types of equipment such as skis, bicycles, kayaks, etc.

Some vehicle roofs have been known to include rain gutters (i.e., “drip rails” or “gutters”). When a vehicle roof includes rain gutters, roof rails may be fastened directly to those gutters. While the gutters offer stability for the roof rails, some modern roof constructions do not have gutters. Without gutters, the roof rails are fastened directly to the roof panel. However, in order to support the roof rails, relatively complex substructures are used to reinforce the roof panel.

One known roof construction is that of DE 199 15 546, which includes a mounting bracket screwed to a vehicle body side wall to reinforce a roof panel. Another known construction is that of DE 10 2005 017 380, in which a roof panel is reinforced by an angled brace connected at one end to a vehicle body side wall and at another end to the roof panel at a location beneath the roof rail. In yet another known roof construction, DE 10 2014 104 920, a roof rail is reinforced by a fastening device which is directly mounted at one end to a vehicle side wall using structural adhesive and hollow rivets.

### SUMMARY

A roof construction for a motor vehicle according to an exemplary aspect of the present disclosure includes, among other things, two side walls, a cross bar extending between the two side walls, a retaining plate connected to the cross bar, a roof panel, and a roof rail connected to the roof panel by a fastener passing through the retaining plate and the roof panel.

In a further non-limiting embodiment of the foregoing roof construction, the roof rail is not connected to the roof panel by way of any fasteners engaging either of the two side walls.

In a further non-limiting embodiment of any of the foregoing roof constructions, the fastener includes a threaded bolt with a head and a threaded shaft, and the threaded shaft passes through a bore in the retaining plate and a hole in the roof panel to engage a nut in the roof rail.

In a further non-limiting embodiment of any of the foregoing roof constructions, the threaded fastener is insertable into the bore and hole from an underside of the roof panel.

In a further non-limiting embodiment of any of the foregoing roof constructions, the bore in the retaining plate is threaded.

In a further non-limiting embodiment of any of the foregoing roof constructions, the hole in the roof panel is not threaded.

In a further non-limiting embodiment of any of the foregoing roof constructions, the roof construction is arranged such that, when the threaded fastener is fully tightened, the head of the threaded bolt is in direct contact with an underside of the retaining plate.

In a further non-limiting embodiment of any of the foregoing roof constructions, seals are arranged between an underside of the roof rail and an upper side of the roof panel on opposite sides of the threaded bolt.

In a further non-limiting embodiment of any of the foregoing roof constructions, the seals extend in a longitudinal direction of the motor vehicle.

In a further non-limiting embodiment of any of the foregoing roof constructions, the retaining plate is connected to the upper side of the cross bar.

In a further non-limiting embodiment of any of the foregoing roof constructions, the retaining plate is welded to the upper side of the cross bar.

In a further non-limiting embodiment of any of the foregoing roof constructions, the cross bar is connected to a flange of the sidewall projecting toward a centerline of the motor vehicle.

In a further non-limiting embodiment of any of the foregoing roof constructions, an upper side of the retaining plate is spaced-apart from an underside of the roof panel.

A motor vehicle according to an exemplary aspect of the present disclosure includes, among other things, two side walls, a cross bar extending between the two side walls, a retaining plate connected to the cross bar, a roof panel, and a roof rail connected to the roof panel by a fastener passing through the retaining plate and the roof panel.

In a further non-limiting embodiment of the foregoing motor vehicle, the roof rail is not connected to the roof panel by way of any fasteners engaging either of the two side walls.

In a further non-limiting embodiment of any of the foregoing motor vehicles, the fastener includes a threaded bolt with a head and a threaded shaft, and the threaded shaft passes through a bore in the retaining plate and a hole in the roof panel to engage a nut in the roof rail.

In a further non-limiting embodiment of any of the foregoing motor vehicles, the roof construction is arranged such that, when the threaded fastener is fully tightened, the head of the threaded bolt is in direct contact with an underside of the retaining plate.

In a further non-limiting embodiment of any of the foregoing motor vehicles, seals are arranged between an underside of the roof rail and an upper side of the roof panel on opposite sides of the threaded bolt.

In a further non-limiting embodiment of any of the foregoing motor vehicles, the retaining plate is connected to the upper side of the cross bar.

In a further non-limiting embodiment of any of the foregoing motor vehicles, an upper side of the retaining plate is spaced-apart from an underside of the roof panel.

### BRIEF DESCRIPTION OF THE DRAWINGS

FIG. 1 is a top view of a roof construction according to this disclosure. In FIG. 1, the roof panel and the roof rail have been omitted for ease of reference.

FIG. 2 is a cross-sectional view taken along line II-II from FIG. 1.

FIG. 3 is a cross-sectional view taken along line III-III from FIG. 1.

### DETAILED DESCRIPTION

This disclosure relates to a roof construction for a motor vehicle. In an example, the roof construction includes two side walls (i.e., side body structures), a cross bar extending between the two side walls, a retaining plate connected to the cross bar, a roof panel, and a roof rail connected to the roof panel by a fastener passing through the retaining plate and the roof panel. The construction of this disclosure is not only less costly but requires less maintenance than prior designs. These and other benefits will be appreciated from the following description.

The disclosed roof construction arrangement uses mostly pre-existing structural elements of a vehicle, with the exception of an additional retaining plate that is directly connected to the cross bar by welding, for example. The retaining plate is not connected directly to the side walls. Further, there are no fasteners connecting the roof rail either directly or indirectly, such as by an intermediate structure like a bracket, to the side walls. In this way, the normal side wall construction is maintained, which preserves the structural integrity of the side wall. In particular, the side walls are connected to the cross bar, as usual, and the retaining plate is connected directly to the upper side of the cross bar in the existing space between the roof panel and the cross bar.

In a further aspect of this disclosure, a space is provided between the upper side of the retaining plate and the underside of the roof panel, so that no friction occurs between the retaining plate and the roof panel.

In another aspect of this disclosure, threaded fasteners are used to fasten the roof rail to the roof panel. In a particular example, a threaded bolt passes through a retaining plate and a hole formed in the roof panel to fasten the roof rail to the roof panel. The threaded bolt can be introduced from below the roof, through the retaining plate and the roof panel, and is screwed into a nut connected to the roof rail. The nut in this case is connected to the lower region of the roof rail. The threaded bolt is tightened to the point such that its head bears against the underside of the retaining plate to securely hold the roof rail relative to the roof.

In still another aspect of this disclosure, seals can be provided between the underside of the roof rail and the upper side of the roof panel on opposite sides of the threaded bolt so that no moisture is able to reach the interior of the vehicle through the roof panel. The seals may be of strip-shaped configuration and run in the longitudinal direction of the roof rail. In addition to performing their sealing function, the seals serve as a means of tightly bridging the gap between the underside of the roof rail and the upper side of the roof panel.

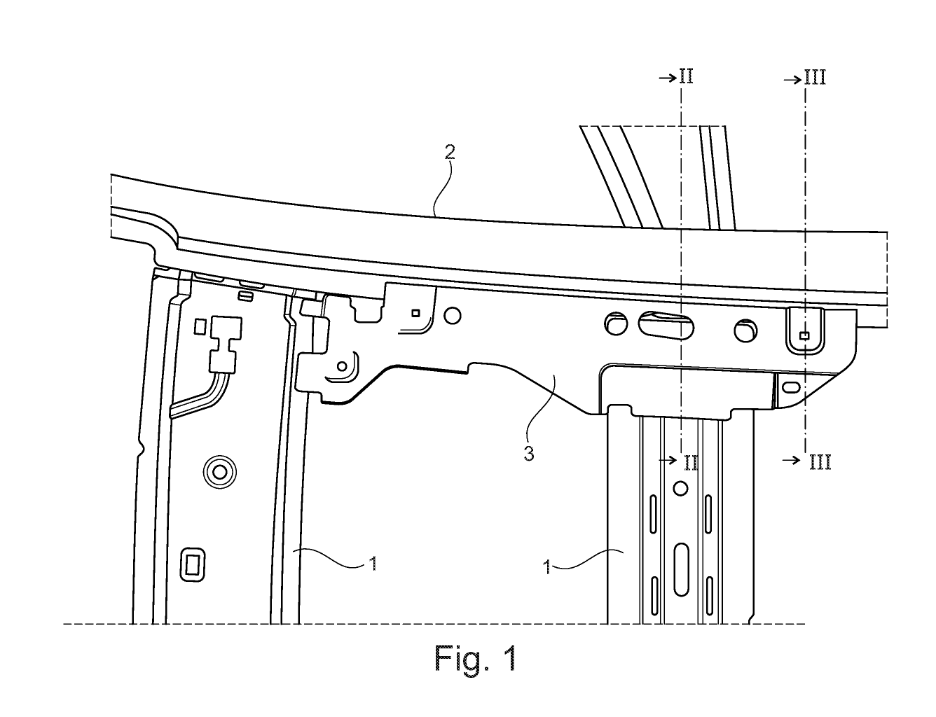

FIG. 1 is a partial view of a roof construction of a motor vehicle. The roof construction of FIG. 1 includes a plurality of cross bars 1 arranged in parallel and connected to the side walls 2 of the vehicle. The side walls 2 are side body structures, in this example. A retaining plate 3 is connected directly to an upper side of at least one of the roof cross bars. In particular, the retaining plate 3 is directly welded to the cross bar 1, using known welding techniques such as spot welding. No adhesives or rivets are used to connect the retaining plate 3 to the cross bar 1.

There is only one retaining plate 3 shown in FIG. 1, but it should be understood this disclosure extends to arrangements with additional retaining plates 3. Further, while only one side of the vehicle is shown in FIG. 1, it should be understood that another, similar retaining plate would be arranged on the opposite side of the vehicle from the retaining plate 3 shown in FIG. 1.

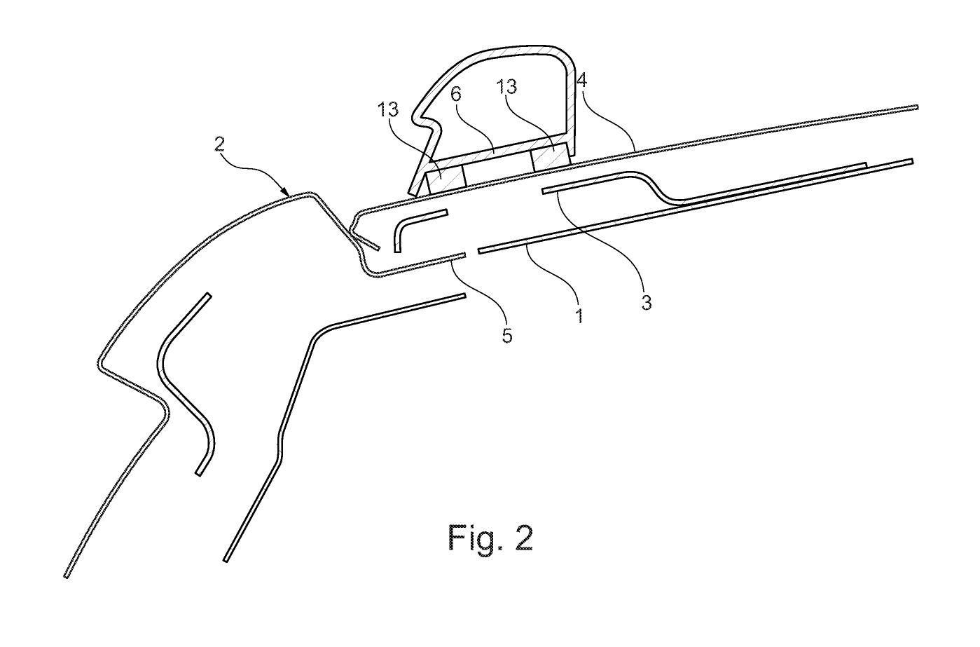

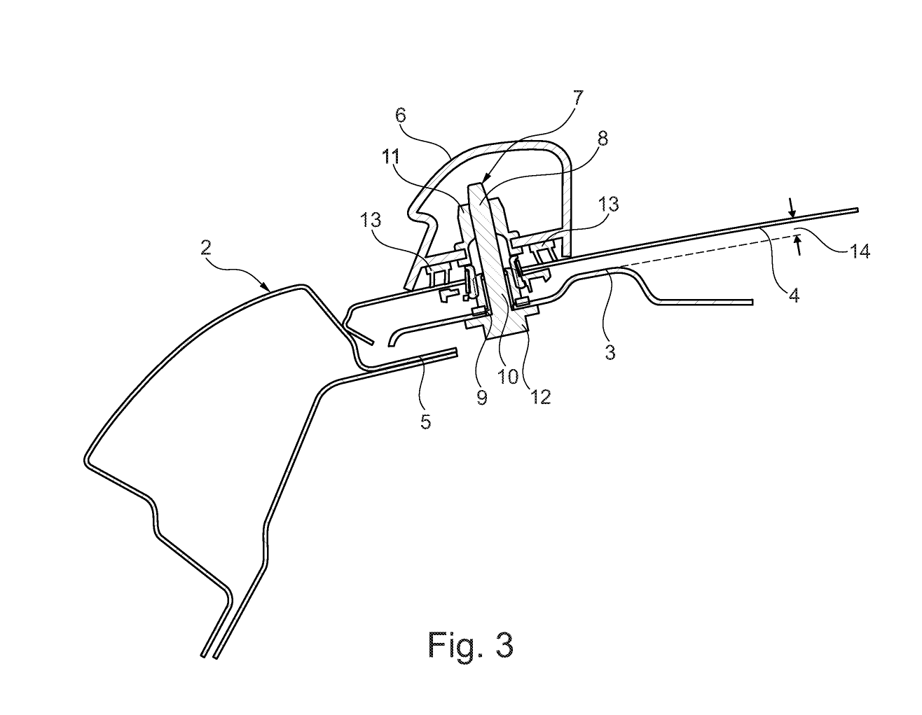

FIGS. 2 and 3 are cross-sectional views taken along lines II-II and III-III, respectively, and illustrate the arrangement of the roof construction of this disclosure in more detail. With joint reference to FIGS. 2 and 3, a roof panel 4 is arranged in a space above the cross bar 1. While FIGS. 2 and 3 are only partial views, it should be understood that the roof panel 4 spans substantially the entire roof area of the vehicle and bears against the side walls 2 on both sides of the vehicle. To this end, FIGS. 2 and 3 are representative of the roof construction present on both sides of the vehicle.

As shown in FIG. 2, the side walls 2 are provided with a flange 5 projecting toward a centerline of the vehicle, and which is connected either directly or indirectly to the cross bar 1. The retaining plate 3 does not directly connect to either the side wall 2 or the flange 5. Rather, again, the retaining plate 3 is directly connected to the cross bar 1. As can be seen in FIG. 2, the retaining plate 3 is arranged entirely in a space between the cross bar 1 and the roof panel 4.

A roof rail 6 is arranged on the upper side of the roof panel 4. Again, while only one roof rail 6 is shown in FIGS. 2 and 3, it should be understood that a similar roof rail would be arranged on the opposite side of the vehicle.

As can be seen in FIG. 3, the roof rail 6 is connected to the retaining plate 3 through the roof panel 4 a fastening element 7. The fastening element 7, in this example, includes a threaded bolt 8 and a nut 11.

The threaded bolt 8 includes a threaded shaft passing through a bore 9 provided in the retaining plate 3 and through a hole 10 formed in the roof panel 4. In one example the bore 9 is a threaded bore and the through hole 10 is not threaded. The threaded bolt 8 engages the retaining plate 3 from below (i.e., beneath the roof panel 4). In other words, the threaded bolt 8 is inserted into the bore and hole 10 in the upward direction, relative to FIG. 3. The threaded bolt 8 is screwed into a nut 11 connected to the roof rail 6. The nut 11 in this case is secured in the lower region of the roof rail 6. The threaded bolt 8 is tightened until its head 12 bears against the underside of the retaining plate 3.

As an alternative, it would also be possible to pass the threaded bolt 8 from above through the roof rail 6, the roof panel 4, and the retaining plate 3, and to secure the threaded bolt 8 with a nut on the underside of the retaining plate 3.

Seals 13, which are of a strip-shaped configuration and extend in the longitudinal direction of the roof rail 6, are arranged between the underside of the roof rail 6 and the upper side of the roof panel 4 on opposite sides (i.e., one on the left and one on the right, relative to FIGS. 2 and 3) of the threaded bolt 8. The seals 13 prevent unwanted moisture from entering the vehicle by bridging the gap between the underside of the roof rail 6 and the upper side of the roof panel 4.

In the assembled state of the roof rail 6, as in FIG. 3, a space 14 remains between the upper side of the retaining plate 3 and the underside of the roof panel 4, so that the roof panel 4 does not come into contact with the retaining plate 3, which prevents unwanted friction between the two.

Further, the retaining plate 3, to which the roof rail 6 is fastened, is connected directly to the respective cross bar 1 and is not in direct connection with the side walls 2. As a result, the structural integrity of the side wall 2 is maintained, and it is possible to position the roof rail 6 relatively far towards the edge of the vehicle roof, because the roof rail position is not constrained by a bracket connecting to the side wall, for example.

Directional terms such as “upper,” “above,” “under,” “below,” “side,” etc., are used herein with reference to the normal operational attitude of a motor vehicle. It should be understood that terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A roof construction for a motor vehicle, comprising:
two side walls;
a cross bar extending between the two side walls;
a retaining plate connected to the cross bar;
a roof panel; and
a roof rail connected to the roof panel by a fastener passing through the retaining plate and the roof panel.

2. The roof construction as recited in claim 1, wherein the roof rail is not connected to the roof panel by way of any fasteners engaging either of the two side walls.

3. The roof construction as recited in claim 1, wherein the fastener includes a threaded bolt with a head and a threaded shaft, and wherein the threaded shaft passes through a bore in the retaining plate and a hole in the roof panel to engage a nut in the roof rail.

4. The roof construction as recited in claim 3, wherein the threaded fastener is insertable into the bore and hole from an underside of the roof panel.

5. The roof construction as recited in claim 3, wherein the bore in the retaining plate is threaded.

6. The roof construction as recited in claim 5, wherein the hole in the roof panel is not threaded.

7. The roof construction as recited in claim 3, wherein the roof construction is arranged such that, when the threaded fastener is fully tightened, the head of the threaded bolt is in direct contact with an underside of the retaining plate.

8. The roof construction as recited in claim 3, wherein seals are arranged between an underside of the roof rail and an upper side of the roof panel on opposite sides of the threaded bolt.

9. The roof construction as recited in claim 8, wherein the seals extend in a longitudinal direction of the motor vehicle.

10. The roof construction as recited in claim 1, wherein the retaining plate is connected to the upper side of the cross bar.

11. The roof construction as recited in claim 10, wherein the retaining plate is welded to the upper side of the cross bar.

12. The roof construction as in claim 10, wherein the cross bar is connected to a flange of the sidewall projecting toward a centerline of the motor vehicle.

13. The roof construction as recited in claim 1, wherein an upper side of the retaining plate is spaced-apart from an underside of the roof panel.

14. A motor vehicle, comprising:
two side walls;
a cross bar extending between the two side walls;
a retaining plate connected to the cross bar;
a roof panel; and
a roof rail connected to the roof panel by a fastener passing through the retaining plate and the roof panel.

15. The motor vehicle as recited in claim 14, wherein the roof rail is not connected to the roof panel by way of any fasteners engaging either of the two side walls.

16. The motor vehicle as recited in claim 14, wherein the fastener includes a threaded bolt with a head and a threaded shaft, and wherein the threaded shaft passes through a bore in the retaining plate and a hole in the roof panel to engage a nut in the roof rail.

17. The motor vehicle as recited in claim 16, wherein the roof construction is arranged such that, when the threaded fastener is fully tightened, the head of the threaded bolt is in direct contact with an underside of the retaining plate.

18. The motor vehicle as recited in claim 16, wherein seals are arranged between an underside of the roof rail and an upper side of the roof panel on opposite sides of the threaded bolt.

19. The motor vehicle as recited in claim 14, wherein the retaining plate is connected to the upper side of the cross bar.

20. The motor vehicle as recited in claim 14, wherein an upper side of the retaining plate is spaced-apart from an underside of the roof panel.
